(19) United States
(12) Patent Application Publication
(10) Pub. No.: US 2025/0103003 A1
(43) Pub. Date: Mar. 27, 2025

(54) GAS SUPPLY APPARATUS AND IMAGE FORMING APPARATUS

(71) Applicant: FUJIFILM Business Innovation Corp., Tokyo (JP)

(72) Inventors: Teruyo Ryuzaki, Kanagawa (JP); Takayuki Suehiro, Kanagawa (JP); Takayuki Kikuchi, Kanagawa (JP)

(73) Assignee: FUJIFILM Business Innovation Corp., Tokyo (JP)

(21) Appl. No.: 18/429,949

(22) Filed: Feb. 1, 2024

(30) Foreign Application Priority Data
Sep. 25, 2023 (JP) 2023-161520

(51) Int. Cl. G03G 21/20

(52) U.S. Cl. CPC G03G 21/206; G03G 2221/1645

(57) ABSTRACT

A gas supply apparatus includes a feed portion that feeds gas, a first flow path through which the gas fed by the feed portion flows, a to-be-supplied portion disposed on the first flow path and to which the gas is supplied, a second flow path through which the gas fed by the feed portion flows, a branch flow path branching off from the second flow path toward the to-be-supplied portion, and a guide portion disposed at a branch portion where the branch flow path branches off from the second flow path to guide, to the branch flow path, a part of the gas that has flowed from the feed portion through the second flow path and that has arrived at the branch portion.

### CROSS-REFERENCE TO RELATED APPLICATIONS

This application is based on and claims priority under 35 USC 119 from Japanese Patent Application No. 2023-161520 filed Sep. 25, 2023.

### BACKGROUND

### (i) Technical Field

The present disclosure relates to a gas supply apparatus and an image forming apparatus.

### (ii) Related Art

Japanese Unexamined Patent Application Publication No. 2014-81403 discloses a structure that allows air from a branch duct to merge with air in an exhaust duct to cause an air flow toward an opening from an opening in the exhaust duct facing a sheet transport path.

Japanese Unexamined Patent Application Publication No. 2019-54026 discloses a structure that includes ducts attached to respective units and a partition board interposed between a door of a housing and the ducts, and in which the partition board has a group of ventholes connecting a vent in the door and the ducts to each other.

Japanese Unexamined Patent Application Publication No. 2012-189836 discloses a structure where a part of a flow path through which lamp heat is discharged is formed from a heat conductor, which also functions as a part of another exhaust flow path, and the lamp heat is transferred with the heat conductor.

### SUMMARY

To supply gas to a to-be-supplied portion that receives the gas, the gas may be supplied to the to-be-supplied portion by being caused to flow through a flow path extending toward the to-be-supplied portion. When the gas does not smoothly flow through the flow path extending toward the to-be-supplied portion, the gas flowing through the flow path is reduced, and fails to be smoothly supplied to the to-be-supplied portion.

Aspects of non-limiting embodiments of the present disclosure relate to more reliably supply gas to a to-be-supplied portion than in a structure including a single flow path for gas directed toward a to-be-supplied portion that receives the gas.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a gas supply apparatus including a feed portion that feeds gas, a first flow path through which the gas fed by the feed portion flows, a to-be-supplied portion disposed on the first flow path and to which the gas is supplied, a second flow path through which the gas fed by the feed portion flows, a branch flow path branching off from the second flow path toward the to-be-supplied portion, and a guide portion disposed at a branch portion where the branch flow path branches off from the second flow path to guide, to the branch flow path, a part of the gas that has flowed from the feed portion through the second flow path and that has arrived at the branch portion.

### BRIEF DESCRIPTION OF THE DRAWINGS

Exemplary embodiments of the present disclosure will be described in detail based on the following figures, wherein:

FIG. 1 is a diagram of an entire structure of an image forming apparatus;

FIG. 2 is a diagram of a bottom portion of a distributor when viewed from a front surface of an image forming apparatus;

FIGS. 3A and 3B are diagrams of the shapes of cross sections of flow paths; and

FIGS. 4A and 4B are schematic diagrams of a layout of flow paths.

### DETAILED DESCRIPTION

An exemplary embodiment of the present disclosure is described below with reference to the drawings.

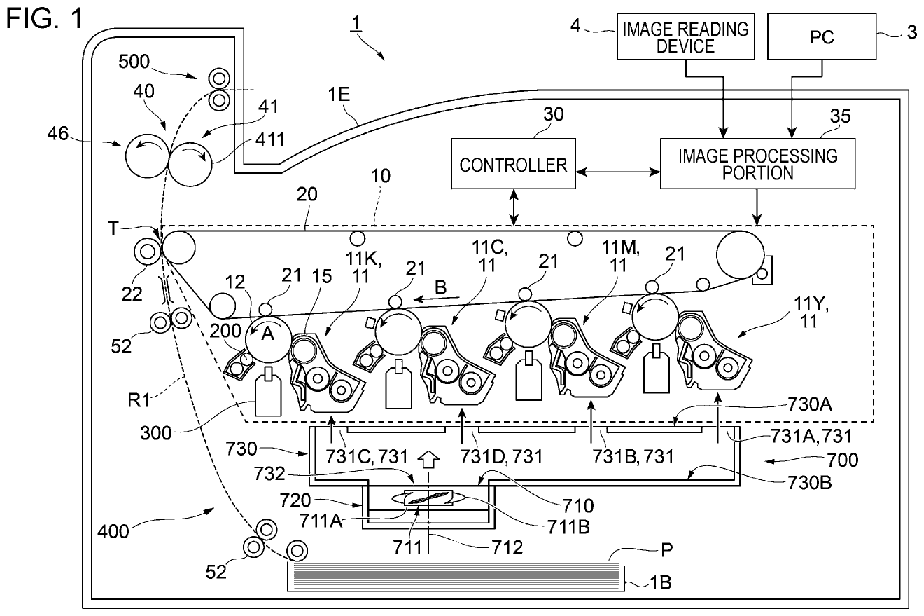

FIG. 1 illustrates the entire structure of an image forming apparatus 1. FIG. 1 illustrates the image forming apparatus 1 when viewed from the front surface of the image forming apparatus 1.

The image forming apparatus 1 includes an image forming portion 10.

The image forming portion 10 forms images on sheets P serving as recording media, based on image data input into the image forming apparatus 1. The image forming apparatus 1 also includes a sheet transport device 400 that transports the sheets P.

In the present exemplary embodiment, the images formed by the image forming portion 10 are transferred to the sheets P transported by the sheet transport device 400.

The sheet transport device 400 transports the sheets P accommodated in a sheet container 1B serving as a container through a second transfer portion T and a fixing device 40 to a sheet receiver 1E at the end.

The sheet transport device 400 includes transport rollers 52 and discharging rollers 500. The sheet transport device 400 transports the sheets P using the transport rollers 52 and the discharging rollers 500.

The image forming apparatus 1 also includes a controller 30 and an image processing portion 35.

The controller 30 controls functional portions in the image forming apparatus 1. The image processing portion 35 performs image processing on image data from components including a personal computer (PC) 3 or an image reading device 4.

The image forming portion 10 includes four image forming units 11Y, 11M, 11C, and 11K (hereafter also collectively and simply referred to as “image forming units 11”) arranged in a row at regular intervals.

Each of the image forming units 11 has the same structure except for toner accommodated in a developing device 15. Each of the image forming units 11 forms toner images (images) of yellow (Y), magenta (M), cyan (C), or black (K).

Each of the image forming units 11 includes a photoconductor drum 12, a charging device 200 that charges the photoconductor drum 12 with electricity, and an exposure device 300 that exposes the photoconductor drum 12 to light.

In the present exemplary embodiment, the charging device 200 charges the photoconductor drum 12 with electricity. The exposure device 300 then exposes the photoconductor drum 12 to light to form an electrostatic latent image on the photoconductor drum 12.

Each of the image forming units 11 also includes a developing device 15 that develops electrostatic latent images formed on the photoconductor drum 12. The developing device 15 performs development to form toner images on the photoconductor drum 12.

The image forming portion 10 also includes an intermediate transfer belt 20 to which the toner images formed on the photoconductor drums 12 are transferred, and first transfer rollers 21 that transfer the toner images formed on the photoconductor drums 12 to the intermediate transfer belt 20.

The image forming portion 10 also includes a second transfer roller 22 that transfers the toner images transferred onto the intermediate transfer belt 20 to sheets P, and a fixing device 40 that fixes the toner images transferred onto the sheets P on the sheets P.

In the present exemplary embodiment, the toner images formed on the photoconductor drums 12 are transferred to the intermediate transfer belt 20, and then transferred from the intermediate transfer belt 20 to the sheets P. The toner images are fixed to the sheets P by the fixing device 40.

The fixing device 40 includes a fixing belt module 41 including a heat source, and a pressing roller 46.

The fixing belt module 41 is disposed on the right of a sheet transport path R1, in the drawing. The pressing roller 46 is disposed on the left of the sheet transport path R1. The pressing roller 46 is pressed against the fixing belt module 41.

The fixing belt module 41 includes a heat source on the inner side of a fixing belt 411 to heat the fixing belt 411.

The image forming apparatus 1 according to the present exemplary embodiment also includes a gas supply apparatus 700 that supplies gas to the image forming portion 10 serving as an example of a predetermined portion, below the image forming portion 10.

The gas supply apparatus 700 is disposed between the image forming portion 10 and the sheet container 1B.

The gas supply apparatus 700 includes a feed portion 710 that feeds the gas to be supplied to the image forming portion 10.

The feed portion 710 is formed from an axial fan. The feed portion 710 may be any fan having a function of feeding gas, and may be other than the axial fan.

The feed portion 710 includes a motor (not illustrated). The feed portion 710 includes a rotation member 711 that is rotated by the motor. The rotation member 711 rotates about a rotation axis 712 extending in the vertical direction.

The rotation member 711 includes a base portion 711A having a cylindrical shape and rotated by the motor, and multiple blade portions 711B protruding from the outer peripheral surface of the base portion 711A.

The blade portions 711B are inclined with respect to a virtual plane (not illustrated) that is perpendicular to the rotation axis 712.

In the feed portion 710, the rotation of the rotation member 711 pushes gas with the blade portions 711B to feed the gas upward in the drawing.

The gas supply apparatus 700 also includes an accommodating member 720 that accommodates the feed portion 710. In the present exemplary embodiment, the feed portion 710 is placed in the accommodating member 720 from above the accommodating member 720.

The accommodating member 720 includes multiple openings (not illustrated). In the present exemplary embodiment, air outside the accommodating member 720 flows into the accommodating member 720 through the multiple openings, and is then supplied to the feed portion 710.

The gas supply apparatus 700 also includes a distributor 730 that distributes the gas fed upward by the feed portion 710. The distributor 730 is disposed between the image forming portion 10 and the feed portion 710.

The distributor 730 is formed from a box-shaped housing, and includes a ceiling portion 730A having four exhaust ports 731. The four exhaust ports 731 are arranged in the left-right direction in the drawing.

In the present exemplary embodiment, the four exhaust ports 731 include a downstream exhaust port 731A disposed most downstream in a gas flow direction in which gas flows, and an upstream exhaust port 731B disposed immediately upstream from the downstream exhaust port 731A in the gas flow direction.

The four exhaust ports 731 also include, as the remaining two exhaust ports 731, an end exhaust port 731C located at the left end of the distributor 730, and an intermediate exhaust port 731D located between the end exhaust port 731C and the upstream exhaust port 731B.

A bottom portion 730B of the distributor 730 has an inlet 732 through which the gas fed by the feed portion 710 flows.

First, the gas fed by the feed portion 710 flows through the inlet 732 and then into the distributor 730.

The gas then flows through the distributor 730 toward the four exhaust ports 731. The gas then flows through the exhaust ports 731 and is fed to the image forming units 11 located above the exhaust ports 731.

The exhaust ports 731 are provided for the respective image forming units 11, and the exhaust ports 731 allow gas to be supplied to the corresponding image forming units 11.

More specifically, the exhaust ports 731 are disposed below the corresponding developing devices 15, and the gas that has flowed through the exhaust ports 731 is supplied to the developing devices 15 located above the exhaust ports 731. Thus, the developing devices 15 are cooled.

In the present exemplary embodiment, the gas from the exhaust ports 731 is thus supplied to the developing devices 15. Instead, the gas from the exhaust ports 731 may be fed to the photoconductor drums 12 or the exposure devices 300.

Air is an example of the gas supplied by the gas supply apparatus 700 to the image forming units 11, but any type of gas other than air may be supplied to the image forming units 11.

In the image forming apparatus 1, the image processing portion 35 performs image processing on the image data from the PC 3 or the image reading device 4, and supplies the image data subjected to the image processing to each of the image forming units 11.

In the image forming unit 11K for black (K), for example, the charging device 200 charges the photoconductor drum 12 that rotates in the direction of arrow A with electricity. The exposure device 300 that emits light based on the image data transmitted from the image processing portion 35 exposes the photoconductor drum 12 to light.

Thus, an electrostatic latent image for an image of black (K) is formed on the photoconductor drum 12. The electrostatic latent image formed on the photoconductor drum 12 is developed by the developing device 15, and a toner image of black (K) is formed on the photoconductor drum 12.

Similarly, the image forming units 11Y, 11M, and 11C form toner images of yellow (Y), magenta (M), and cyan (C).

The toner images of different colors formed on the respective image forming units 11 are sequentially electrostatically attracted by the first transfer rollers 21 onto the intermediate transfer belt 20 that moves in the direction of arrow B, and superposed to form a superposed toner image on the intermediate transfer belt 20.

The superposed toner image on the intermediate transfer belt 20 is transported by the movement of the intermediate transfer belt 20 to a second transfer portion T formed by the second transfer roller 22.

At the timing when the toner image arrives at the second transfer portion T, the sheet P is fed to the second transfer portion T from the sheet container 1B.

At the second transfer portion T, a transfer electric field formed by the second transfer roller 22 collectively electrostatically transfers the toner image on the intermediate transfer belt 20 to the sheet P transported to the second transfer portion T.

The sheet P to which the toner image is electrostatically transferred is then removed from the intermediate transfer belt 20, and transported to the fixing device 40.

The fixing device 40 holds the sheet P using the fixing belt module 41 and the pressing roller 46. More specifically, the fixing device 40 holds the sheet P with the fixing belt 411 that rotates in the clockwise direction in the drawing, and the pressing roller 46 that rotates in the counterclockwise direction.

Thus, the sheet P is pressed and heated, and the toner image on the sheet P is fixed onto the sheet P. The sheet P that has undergone fixing is then transported to the sheet receiver 1E by the discharging rollers 500.

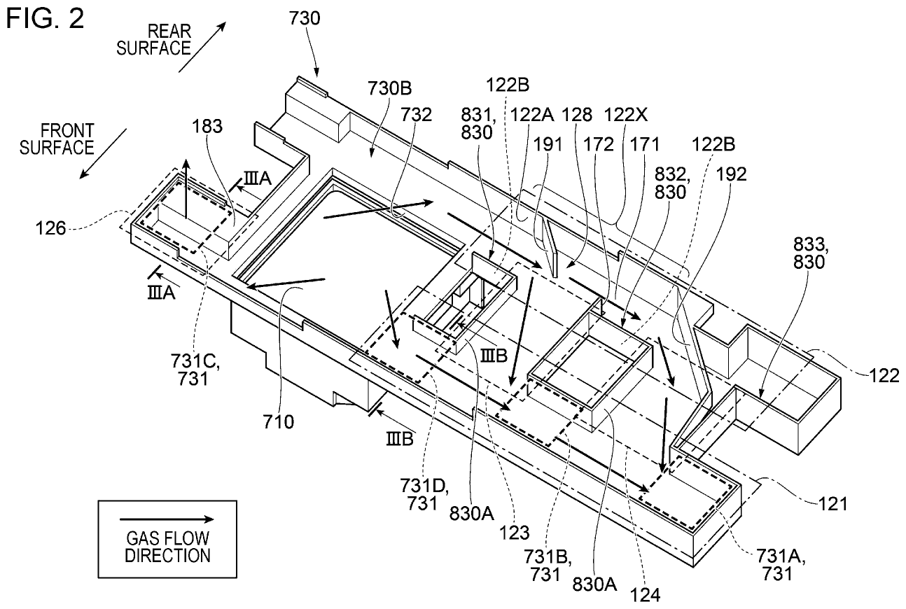

FIG. 2 is a diagram of the bottom portion 730B of the distributor 730 when viewed from a front surface of the image forming apparatus 1. FIG. 2 also illustrates the four exhaust ports 731 formed in the ceiling portion 730A (refer to FIG. 1) of the distributor 730.

In the present exemplary embodiment, a linear first flow path 121 through which the gas fed by the feed portion 710 flows is located in the distributor 730 at a portion nearer the front surface of the image forming apparatus 1.

The first flow path 121 extends in the direction in which the multiple image forming units 11 (refer to FIG. 1) are arranged.

In the present exemplary embodiment, the intermediate exhaust port 731D, the upstream exhaust port 731B, and the downstream exhaust port 731A illustrated in FIG. 1 are formed on the first flow path 121.

The three exhaust ports 731, that is, the intermediate exhaust port 731D, the upstream exhaust port 731B, and the downstream exhaust port 731A are arranged in this order in the gas flow direction in which gas flows through the first flow path 121.

In the present exemplary embodiment, the gas supplied by the feed portion 710 flows through the first flow path 121 to be supplied to the intermediate exhaust port 731D, the upstream exhaust port 731B, and the downstream exhaust port 731A.

In the present exemplary embodiment, the distributor 730 also includes a linear second flow path 122 through which the gas fed by the feed portion 710 flows.

In the present exemplary embodiment, the second flow path 122 allows gas to be supplied to the upstream exhaust port 731B and the downstream exhaust port 731A.

This structure further increases the amount of gas supplied to the upstream exhaust port 731B and the downstream exhaust port 731A than a structure not including the second flow path 122.

In the present exemplary embodiment, the distributor 730 includes regulators 830 (described later in detail). The regulators 830 reduce the cross-sectional area of the first flow path 121 flowing through the intermediate exhaust port 731D, the upstream exhaust port 731B, and the downstream exhaust port 731A.

In this structure, the amount of gas supplied to the upstream exhaust port 731B and the downstream exhaust port 731A is likely to be reduced. However, the structure in the present exemplary embodiment including the second flow path 122 increases the amount of gas supplied to the upstream exhaust port 731B and the downstream exhaust port 731A.

The second flow path 122 is located in the distributor 730 at a portion closer to the rear surface of the image forming apparatus 1 than the first flow path 121.

As in the first flow path 121, the second flow path 122 extends in the direction in which the multiple image forming units 11 (refer to FIG. 1) are arranged.

The first flow path 121 and the second flow path 122 are arranged parallel to each other. In the present exemplary embodiment, the direction in which the first flow path 121 extends and the direction in which the second flow path 122 extends coincide with each other.

In the present exemplary embodiment, the gas flowing through the first flow path 121 and the gas flowing through the second flow path 122 are the gas fed by the common feed portion 710.

In the present exemplary embodiment, gas is supplied from the common feed portion 710 to the first flow path 121 and the second flow path 122. In other words, in the present exemplary embodiment, gas is supplied from the same feed portion 710 to the first flow path 121 and the second flow path 122.

In the present exemplary embodiment, the gas flowing through the first flow path 121 and the gas flowing through the second flow path 122 are the gas fed by the same feed portion 710.

In the present exemplary embodiment, a branch flow path 123 branches off from the second flow path 122 toward the upstream exhaust port 731B serving as an example of an upstream to-be-supplied portion.

The branch flow path 123 is connected to a portion of the first flow path 121 located between the intermediate exhaust port 731D and the upstream exhaust port 731B.

In the present exemplary embodiment, at a branch portion 128 where the branch flow path 123 branches off from the second flow path 122, a first guide portion 191 is disposed to cross the second flow path 122.

The first guide portion 191 is formed from a plate-shaped member.

The first guide portion 191 is not limited to a plate-shaped member. For example, the first guide portion 191 may be formed from a portion of the inner surface of the distributor 730 located further inward, in the distributor 730, from the other portion of the inner surface of the distributor 730.

The first guide portion 191 guides, to the branch flow path 123, a part of the gas that has flowed from the feed portion 710 through the second flow path 122 and arrived at the branch portion 128.

The first guide portion 191 is inclined with respect to the direction in which the second flow path 122 extends.

The first guide portion 191 is located closer to the first flow path 121 as it extends further downstream in the gas flow direction in the second flow path 122.

The first guide portion 191 is located closer to a first inner surface 122A of the two inner surfaces of the second flow path 122 located further from the first flow path 121.

The second flow path 122 has a rectangular cross section, and has a first inner surface 122A and a second inner surface 122B that oppose each other.

The first inner surface 122A is located further from the first flow path 121, and the second inner surface 122B is located closer to the first flow path 121 than the first inner surface 122A.

The first guide portion 191 is disposed on the first inner surface 122A of the two inner surfaces of the second flow path 122 located further from the first flow path 121.

The gas moved to the first guide portion 191 through the second flow path 122 is moved toward the second inner surface 122B while being guided by the first guide portion 191.

A part of the gas moved toward the second inner surface 122B is directed toward the branch flow path 123. The other part of the gas moved toward the second inner surface 122B moves downstream through the second flow path 122 without being directed toward the branch flow path 123.

In a structure not including the first guide portion 191, gas flowing through the second flow path 122 flows by the branch portion 128 and is less likely to be directed toward the branch flow path 123. In this structure, the amount of gas discharged from the upstream exhaust port 731B is more likely to be reduced.

In contrast, the structure including the first guide portion 191 as in the present exemplary embodiment allows the gas flowing through the second flow path 122 to be more easily directed toward the branch flow path 123, and the amount of gas discharged from the upstream exhaust port 731B increases.

In the present exemplary embodiment, the second flow path 122 has a smaller area portion 171 at a portion downstream from the branch portion 128, at which the second flow path 122 partially has a small cross section.

The second flow path 122 has a protrusion 172 at a portion downstream from the branch portion 128, which protrudes inward into the second flow path 122 from the inner surface of the second flow path 122. The protrusion 172 protrudes from the second inner surface 122B of the second flow path 122 toward the first inner surface 122A.

In the present exemplary embodiment, the protrusion 172 partially reduces the cross section of the second flow path 122 to define the smaller area portion 171 in the second flow path 122.

The structure including the smaller area portion 171 allows the gas in the second flow path 122 to be more easily directed toward the branch flow path 123 than a structure not including the smaller area portion 171.

The second flow path 122 includes a linear portion 122X.

In the present exemplary embodiment, a portion of the second flow path 122 extending from a position upstream from the branch portion 128 through the branch portion 128 to a position downstream from the branch portion 128 is the linear portion 122X.

The branch flow path 123 is connected to the linear portion 122X of the second flow path 122.

The branch flow path 123 crosses the direction in which the linear portion 122X of the second flow path 122 extends. More specifically, the branch flow path 123 is perpendicular to the direction in which the linear portion 122X of the second flow path 122 extends.

The first guide portion 191 is inclined with respect to the direction in which the linear portion 122X of the second flow path 122 extends.

In the present exemplary embodiment, the upstream exhaust port 731B serving as an example of a to-be-supplied portion to which gas is supplied is disposed on the first flow path 121.

In addition, the downstream exhaust port 731A serving as an example of a downstream to-be-supplied portion to which gas that has flowed through the first flow path 121 is supplied is disposed downstream from the upstream exhaust port 731B in the gas flow direction.

In the present exemplary embodiment, the gas that has flowed from the branch portion 128 through the second flow path 122 without being directed toward the branch flow path 123 is directed toward the downstream exhaust port 731A and arrives at the downstream exhaust port 731A. The gas is then discharged from the downstream exhaust port 731A.

In the present exemplary embodiment, a connection flow path 124 that is connected to the second flow path 122 and crosses the second flow path 122 is also disposed. The connection flow path 124 extends from the second flow path 122 toward the downstream exhaust port 731A.

A part of the gas in the second flow path 122 that has flowed through the smaller area portion 171 flows through the connection flow path 124 toward the downstream exhaust port 731A.

In addition, a second guide portion 192 inclined with respect to the direction in which the second flow path 122 extends is disposed at a portion where the second flow path 122 and the connection flow path 124 are connected to each other.

The second guide portion 192 is located closer to the first inner surface 122A of the second flow path 122.

The second guide portion 192 is formed from the inner surface of the distributor 730. Instead, the second guide portion 192 may be formed from a plate-shaped member, as in the case of the first guide portion 191.

In the present exemplary embodiment, the gas that has flowed through the second flow path 122 past the smaller area portion 171 is directed toward the connection flow path 124 while being guided by the second guide portion 192.

In the present exemplary embodiment, a third flow path 126 through which the gas fed by the feed portion 710 flows is also disposed.

The third flow path 126 is disposed on the extension line of the first flow path 121. The third flow path 126 is disposed across the inlet 732 from the first flow path 121.

The end exhaust port 731C serving as an example of a to-be-supplied portion to which the gas that has flowed through the third flow path 126 is supplied is disposed on the third flow path 126.

In the present exemplary embodiment, one to-be-supplied portion is disposed on the third flow path 126. More specifically, in the present exemplary embodiment, one end exhaust port 731C is disposed on the third flow path 126, or only one exhaust port 731 is disposed on the third flow path 126.

In the present exemplary embodiment, the first flow path 121 has the multiple exhaust ports 731, whereas the third flow path 126 has one exhaust port 731.

The third flow path 126 is closed at a portion downstream from the end exhaust port 731C disposed on the third flow path 126 in the gas flow direction.

In the present exemplary embodiment, the third flow path 126 has a smaller cross-sectional area than the first flow path 121. Herein, the cross-sectional area of the flow path indicates the cross-sectional area of the flow path on the surface perpendicular to the direction in which the flow path extends.

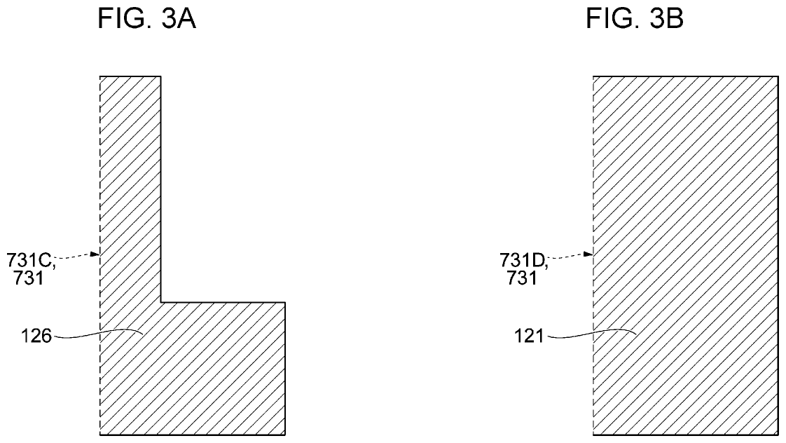

FIGS. 3A and 3B are diagrams of the shapes of cross sections of flow paths.

FIG. 3A illustrates the cross-sectional shape of the third flow path 126 taken along line IIIA-IIIA in FIG. 2, and FIG. 3B illustrates the cross-sectional shape of the first flow path 121 taken along line IIIB-IIIB in FIG. 2.

In the present exemplary embodiment, as illustrated in FIGS. 3A and 3B, the third flow path 126 has a smaller cross section than the first flow path 121.

As illustrated in FIG. 2, at a portion where the third flow path 126 is formed, a protrusion 183 protrudes upward above the bottom portion 730B of the distributor 730.

In the present exemplary embodiment, the protrusion 183 further reduces the cross section of the third flow path 126 than the cross section of the first flow path 121.

In the present exemplary embodiment, as illustrated in FIG. 2, the end exhaust port 731C is located near the inlet 732. This structure facilitates discharge of the gas that has flowed into the distributor 730 through the inlet 732 from the end exhaust port 731C located near the inlet 732.

In this case, the amount of gas supplied to the developing devices 15 (refer to FIG. 1) has differences, and the developing devices 15 are cooled to varying degrees.

To avoid this, in the structure in the present exemplary embodiment where the third flow path 126 has a smaller cross section than the first flow path 121, the gas directed toward the end exhaust port 731C is reduced. In this structure, the amount of gas supplied to the developing devices 15 (refer to FIG. 1) has smaller differences, and the developing devices 15 are cooled to degrees that vary less.

In the present exemplary embodiment, the intermediate exhaust port 731D disposed on the first flow path 121 is also located near the inlet 732. This structure allows the gas that has flowed into the distributor 730 through the inlet 732 to be smoothly discharged from the intermediate exhaust port 731D, but the amount of gas discharged from the intermediate exhaust port 731D is smaller than that discharged from the end exhaust port 731C.

The intermediate exhaust port 731D is located at a portion on the first flow path 121, and a part of the gas flowing through the first flow path 121 flows through the intermediate exhaust port 731D toward the upstream exhaust port 731B. In this structure, the amount of gas discharged from the intermediate exhaust port 731D is reduced.

In contrast, the third flow path 126 is closed at a portion downstream from the end exhaust port 731C in the gas flow direction, and the gas flowing through the third flow path 126 converges on the end exhaust port 731C, and the amount of gas discharged from the end exhaust port 731C increases.

As in the present exemplary embodiment where the third flow path 126 has a cross section smaller than the first flow path 121, the gas directed toward the end exhaust port 731C is reduced, and the amount of gas discharged from the end exhaust port 731C is reduced.

In this structure, the amount of gas supplied to the developing devices 15 has smaller differences.

As described above, as illustrated in FIG. 2, the present exemplary embodiment includes the upstream exhaust port 731B and the downstream exhaust port 731A.

The upstream exhaust port 731B and the downstream exhaust port 731A are disposed on the first flow path 121 at different positions in the gas flow direction. In the present exemplary embodiment, the upstream exhaust port 731B and the downstream exhaust port 731A serve as examples of multiple to-be-supplied portions to which the gas that has flowed through the first flow path 121 is supplied.

The present exemplary embodiment includes the second flow path 122 through which the gas fed by the feed portion 710 flows and through which the gas to be supplied to the upstream exhaust port 731B and the downstream exhaust port 731A serving as multiple to-be-supplied portions flows.

The present exemplary embodiment also includes supply flow paths disposed to cross the first flow path 121 and the second flow path 122 in correspondence with the multiple exhaust ports 731 to supply the gas in the second flow path 122 to the exhaust ports 731.

The present exemplary embodiment includes the branch flow path 123 and the connection flow path 124 serving as the supply flow paths.

As illustrated in FIG. 2, the present exemplary embodiment includes the multiple regulators 830 that regulate the flow of gas in the distributor 730.

These multiple regulators 830 are disposed between the first flow path 121 and the second flow path 122, and arranged in the direction in which the first flow path 121 and the second flow path 122 extend.

In the present exemplary embodiment, the regulators 830 include a first regulator 831, a second regulator 832, and a third regulator 833.

The first regulator 831 to the third regulator 833 are arranged in this order in the gas flow direction in which gas flows through the first flow path 121 and the second flow path 122.

Each of the regulators 830 includes a wall portion 830A. In the present exemplary embodiment, various components (not illustrated) are disposed in a rectangular-prism space surrounded by the wall portion 830A.

In the present exemplary embodiment, the supply flow paths extending from the second flow path 122 toward the exhaust ports 731 serving as the to-be-supplied portions extend toward the exhaust ports 731 between the regulators 830 adjacent to each other.

As described above, the present exemplary embodiment includes the branch flow path 123 and the connection flow path 124 serving as the supply flow paths extending to the exhaust ports 731 serving as the to-be-supplied portions.

The branch flow path 123 extends toward the upstream exhaust port 731B between the first regulator 831 and the second regulator 832. The connection flow path 124 extends toward the downstream exhaust port 731A between the second regulator 832 and the third regulator 833.

The present exemplary embodiment includes guide portions at portions where the second flow path 122 and the supply flow paths are connected. The guide portions are inclined with respect to the direction in which the second flow path 122 extends to guide the gas that has flowed through the second flow path 122 to the supply flow paths.

The present exemplary embodiment includes the first guide portion 191 and the second guide portion 192 as the guide portions.

The first guide portion 191 is disposed at a portion where the second flow path 122 and the branch flow path 123 serving as an example of the supply flow path are connected to guide the gas that has flowed through the second flow path 122 to the branch flow path 123.

The second guide portion 192 is disposed at a portion where the second flow path 122 and the connection flow path 124 serving as another example of the supply flow path are connected to guide the gas that has flowed through the second flow path 122 to the connection flow path 124.

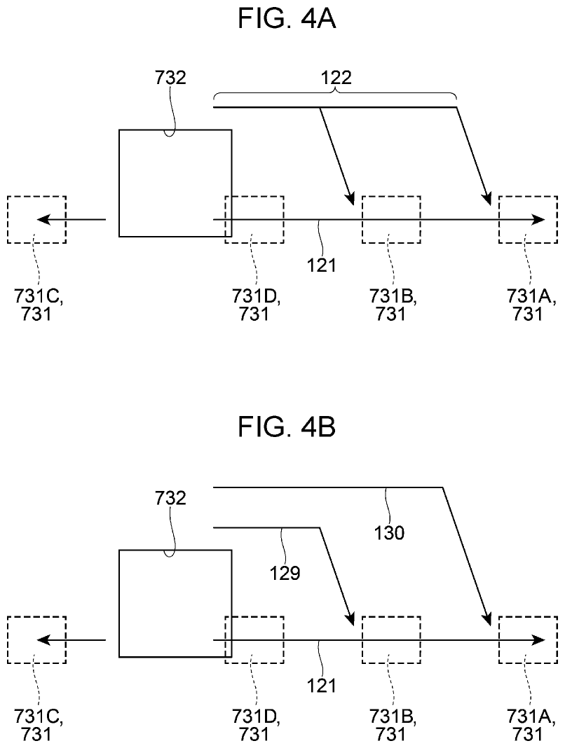

FIGS. 4A and 4B are schematic diagrams of a layout of flow paths.

As described above, as illustrated in FIG. 4A, in the present exemplary embodiment, gas is supplied to the upstream exhaust port 731B and the downstream exhaust port 731A using the common second flow path 122 separately provided as a flow path different from the first flow path 121.

As illustrated in, for example, FIG. 4B, other flow paths may be provided in correspondence with the upstream exhaust port 731B and the downstream exhaust port 731A.

The example illustrated in FIG. 4B separately includes a flow path 129 corresponding to the upstream exhaust port 731B, and a flow path 130 corresponding to the downstream exhaust port 731A. The example illustrated in FIG. 4B individually includes the flow path 129 and the flow path 130.

The example illustrated in FIG. 4B further increases the volume of the flow path in the image forming apparatus 1 than the example illustrated in FIG. 4A, and may increase the size of the image forming apparatus 1.

In contrast, the example in FIG. 4A includes the common second flow path 122 corresponding to the multiple exhaust ports 731, and easily reduces the size of the image forming apparatus 1.

### Others

In the above description, for example, the image forming apparatus 1 includes the gas supply apparatus 700, which supplies gas to a part of the image forming apparatus 1.

However, the gas supply apparatus 700 may supply the gas to another destination other than a part of the image forming apparatus 1. The gas supply apparatus 700 may supply gas to a part of an apparatus other than the image forming apparatus 1.

The gas supply apparatus 700 may be installed at a portion other than the image forming apparatus 1. For example, the gas supply apparatus 700 may be installed at a transport device such as an automobile, an air conditioning device such as an air conditioner, or an information processing device such as a computer.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1))) A gas supply apparatus comprising:
a feed portion that feeds gas;
a first flow path through which the gas fed by the feed portion flows;
a to-be-supplied portion disposed on the first flow path and to which the gas is supplied;
a second flow path through which the gas fed by the feed portion flows;
a branch flow path branching off from the second flow path toward the to-be-supplied portion; and
a guide portion disposed at a branch portion where the branch flow path branches off from the second flow path to guide, to the branch flow path, a part of the gas that has flowed from the feed portion through the second flow path and that has arrived at the branch portion.

(((2))) The gas supply apparatus according to (((1))),
wherein gas that flows through the first flow path and gas that flows through the second flow path are the gas fed by the feed portion.

(((3))) The gas supply apparatus according to (((1))) or (((2))),
wherein the second flow path has a cross section partially reduced at a portion downstream from the branch portion.

(((4))) The gas supply apparatus according to (((3))),
wherein the second flow path has a protrusion at a portion downstream from the branch portion, the protrusion protrudes inward into the second flow path from an inner surface of the second flow path, and the protrusion partially reduces the cross section of the second flow path.

(((5))) The gas supply apparatus according to (((1))),
wherein a portion of the second flow path linearly extends from a position upstream from the branch portion through the branch portion to a position downstream from the branch portion to form a linear portion extending from an upstream side to a downstream side.

(((6))) The gas supply apparatus according to (((5))),
wherein the branch flow path crosses a direction in which the linear portion of the second flow path extends.

(((7))) The gas supply apparatus according to (((5))),
wherein the guide portion is inclined with respect to a direction in which the linear portion of the second flow path extends.

(((8))) The gas supply apparatus according to (((1))), further comprising:
a downstream to-be-supplied portion to which gas that has flowed through the first flow path is supplied, the downstream to-be-supplied portion being disposed on the first flow path downstream from an upstream to-be-supplied portion serving as the to-be-supplied portion in a gas flow direction,
wherein gas that has flowed from the branch portion through the second flow path without flowing toward the branch flow path is supplied to the downstream to-be-supplied portion.

(((9))) The gas supply apparatus according to (((8))),
wherein the first flow path and the second flow path are arranged parallel to each other,
wherein a connection flow path connected to the second flow path and crossing the second flow path is further disposed, and gas flowing from the second flow path to the downstream to-be-supplied portion flows through the connection flow path, and
wherein a guide portion inclined with respect to a direction in which the second flow path extends is disposed at a portion where the second flow path and the connection flow path are connected to guide gas that has flowed through the second flow path to the connection flow path.

(((10))) The gas supply apparatus according to (((1))), further comprising:
a third flow path through which gas fed by the feed portion flows; and
a to-be-supplied portion disposed on the third flow path and to which the gas is supplied,
wherein the third flow path is closed at a portion downstream from the to-be-supplied portion disposed on the third flow path in a gas flow direction,
wherein a plurality of to-be-supplied portions including the to-be-supplied portion disposed on the first flow path and another to-be-supplied portion are disposed on the first flow path, and
wherein the third flow path has a smaller cross section than the first flow path.

(((11))) A gas supply apparatus comprising:
a feed portion that feeds gas;
a first flow path through which the gas fed by the feed portion flows;
a plurality of to-be-supplied portions disposed on the first flow path at different positions in a gas flow direction and to which the gas that has flowed through the first flow path is supplied; and
a second flow path through which the gas fed by the feed portion flows, and through which the gas to be supplied to the plurality of to-be-supplied portions flows.

(((12))) The gas supply apparatus according to (((11))),
wherein the first flow path and the second flow path are arranged parallel to each other.

(((13))) The gas supply apparatus according to (((12))), further comprising:
supply flow paths disposed to cross the first flow path and the second flow path in correspondence with the plurality of to-be-supplied portions to supply gas in the second flow path to the to-be-supplied portions.

(((14))) The gas supply apparatus according to (((13))), further comprising:
a plurality of regulators disposed between the first flow path and the second flow path and arranged in a direction in which the first flow path and the second flow path extend to regulate a flow of gas,
wherein the supply flow paths extending from the second flow path toward the to-be-supplied portion extend toward the to-be-supplied portions between the regulators adjacent to each other.

(((15))) The gas supply apparatus according to (((13))) or (((14))),
wherein guide portions inclined with respect to a direction in which the second flow path extends are disposed at portions where the second flow path and the supply flow paths are connected to guide gas that has flowed through the second flow path to the supply flow paths.

(((16))) An image forming apparatus that forms an image on a recording medium, comprising:
a gas supply apparatus that supplies gas to a predetermined portion,
wherein the gas supply apparatus includes the gas supply apparatus according to any one of (((1))) to (((15))).

What is claimed is:

1. A gas supply apparatus comprising:
a feed portion that feeds gas;
a first flow path through which the gas fed by the feed portion flows;
a to-be-supplied portion disposed on the first flow path and to which the gas is supplied;
a second flow path through which the gas fed by the feed portion flows;
a branch flow path branching off from the second flow path toward the to-be-supplied portion; and
a guide portion disposed at a branch portion where the branch flow path branches off from the second flow path to guide, to the branch flow path, a part of the gas that has flowed from the feed portion through the second flow path and that has arrived at the branch portion.

2. The gas supply apparatus according to claim 1,
wherein gas that flows through the first flow path and gas that flows through the second flow path are the gas fed by the feed portion.

3. The gas supply apparatus according to claim 1,
wherein the second flow path has a cross section partially reduced at a portion downstream from the branch portion.

4. The gas supply apparatus according to claim 3,
wherein the second flow path has a protrusion at a portion downstream from the branch portion, the protrusion protrudes inward into the second flow path from an inner surface of the second flow path, and the protrusion partially reduces the cross section of the second flow path.

5. The gas supply apparatus according to claim 1,
wherein a portion of the second flow path linearly extends from a position upstream from the branch portion through the branch portion to a position downstream from the branch portion to form a linear portion extending from an upstream side to a downstream side.

6. The gas supply apparatus according to claim 5,
wherein the branch flow path crosses a direction in which the linear portion of the second flow path extends.

7. The gas supply apparatus according to claim 5,
wherein the guide portion is inclined with respect to a direction in which the linear portion of the second flow path extends.

8. The gas supply apparatus according to claim 1, further comprising:
a downstream to-be-supplied portion to which gas that has flowed through the first flow path is supplied, the downstream to-be-supplied portion being disposed on the first flow path downstream from an upstream to-be-supplied portion serving as the to-be-supplied portion in a gas flow direction,
wherein gas that has flowed from the branch portion through the second flow path without flowing toward the branch flow path is supplied to the downstream to-be-supplied portion.

9. The gas supply apparatus according to claim 8,
wherein the first flow path and the second flow path are arranged parallel to each other,
wherein a connection flow path connected to the second flow path and crossing the second flow path is further disposed, and gas flowing from the second flow path to the downstream to-be-supplied portion flows through the connection flow path, and
wherein a guide portion inclined with respect to a direction in which the second flow path extends is disposed at a portion where the second flow path and the connection flow path are connected to guide gas that has flowed through the second flow path to the connection flow path.

10. The gas supply apparatus according to claim 1, further comprising:
a third flow path through which gas fed by the feed portion flows; and
a to-be-supplied portion disposed on the third flow path and to which the gas is supplied,
wherein the third flow path is closed at a portion downstream from the to-be-supplied portion disposed on the third flow path in a gas flow direction,
wherein a plurality of to-be-supplied portions including the to-be-supplied portion disposed on the first flow path and another to-be-supplied portion are disposed on the first flow path, and
wherein the third flow path has a smaller cross section than the first flow path.

11. A gas supply apparatus comprising:
a feed portion that feeds gas;
a first flow path through which the gas fed by the feed portion flows;
a plurality of to-be-supplied portions disposed on the first flow path at different positions in a gas flow direction and to which the gas that has flowed through the first flow path is supplied; and
a second flow path through which the gas fed by the feed portion flows, and through which the gas to be supplied to the plurality of to-be-supplied portions flows.

12. The gas supply apparatus according to claim 11,
wherein the first flow path and the second flow path are arranged parallel to each other.

13. The gas supply apparatus according to claim 12, further comprising:
supply flow paths disposed to cross the first flow path and the second flow path in correspondence with the plurality of to-be-supplied portions to supply gas in the second flow path to the to-be-supplied portions.

14. The gas supply apparatus according to claim 13, further comprising:
a plurality of regulators disposed between the first flow path and the second flow path and arranged in a direction in which the first flow path and the second flow path extend to regulate a flow of gas,
wherein the supply flow paths extending from the second flow path toward the to-be-supplied portion extend toward the to-be-supplied portions between the regulators adjacent to each other.

15. The gas supply apparatus according to claim 13,
wherein guide portions inclined with respect to a direction in which the second flow path extends are disposed at portions where the second flow path and the supply flow paths are connected to guide gas that has flowed through the second flow path to the supply flow paths.

16. An image forming apparatus that forms an image on a recording medium, comprising:
a gas supply apparatus that supplies gas to a predetermined portion,
wherein the gas supply apparatus includes the gas supply apparatus according to claim 1.

17. An image forming apparatus that forms an image on a recording medium, comprising:
a gas supply apparatus that supplies gas to a predetermined portion,
wherein the gas supply apparatus includes the gas supply apparatus according to claim 2.

18. An image forming apparatus that forms an image on a recording medium, comprising:
a gas supply apparatus that supplies gas to a predetermined portion,
wherein the gas supply apparatus includes the gas supply apparatus according to claim 3.

19. An image forming apparatus that forms an image on a recording medium, comprising:
a gas supply apparatus that supplies gas to a predetermined portion,
wherein the gas supply apparatus includes the gas supply apparatus according to claim 4.

20. An image forming apparatus that forms an image on a recording medium, comprising:
a gas supply apparatus that supplies gas to a predetermined portion,
wherein the gas supply apparatus includes the gas supply apparatus according to claim 5.
